(19) United States
(12) Patent Application Publication
(10) Pub. No.: US 2020/0226618 A1
(43) Pub. Date: Jul. 16, 2020

(54) PLATFORM, METHOD AND DEVICE FOR TRACING AN OBJECT

(71) Applicants: BEIJING JINGDONG SHANGKE INFORMATION TECHNOLOGY CO., LTD., Beijing (CN); BEIJING JINGDONG CENTURY TRADING CO., LTD., Beijing (CN)

(72) Inventor: Wei ZHANG, Beijing (CN)

(73) Assignees: BEIJING JINGDONG SHANGKE INFORMATION TECHNOLOGY CO., LTD., Beijing (CN); BEIJING JINGDONG CENTURY TRADING CO., LTD., Beijing (CN)

(21) Appl. No.: 16/650,887

(22) PCT Filed: Aug. 23, 2018
(86) PCT No.: PCT/CN2018/101948

§ 371 Date: Mar. 26, 2020

(30) Foreign Application Priority Data
Sep. 29, 2017 (CN) 201710902097.9

(51) Int. Cl. G06Q 30/00; H04L 9/06; G06Q 30/06

(52) U.S. Cl. CPC G06Q 30/0185; H04L 9/0637; H04L 2209/56; H04L 2209/38; G06Q 30/0609

(57) ABSTRACT

A platform, method and device for tracing an object, relating to the field of information tracing. The platform includes: a plurality of blockchain nodes, wherein each blockchain node corresponds to an entity in object circulation; and each blockchain node is configured to record circulation information of an object that is circulated to the blockchain node in association with a traceability code of the object, and the plurality of blockchain nodes synchronize the traceability code and the circulation information about the object by using blockchain synchronization technology.

### CROSS-REFERENCE TO RELATED APPLICATIONS

The present disclosure is based on and claims priority of Chinese patent application NO. 201710902097.9, filed on Sep. 29, 2017, the disclosure of which is hereby incorporated into this disclosure by reference in its entirety.

### TECHNICAL FIELD

The present disclosure relates to the field of information tracing, and particularly relates to a platform, method and device for tracing an object.

### BACKGROUND

Objects often circulate between multiple entities. For example, an object from its production to its sale may pass through entities such as a manufacturer, a seller, a transport organization. Circulation information is generated when an object is in circulation, and some users or services may have a need to trace this circulation information (that is, the need to trace the source).

### SUMMARY

The inventor has found that it is difficult to communicate circulation information between multiple entities in object circulation, and complete and unified traceability of circulation information in the life cycle of objects is difficult to achieve.

A technical problem to be solved by the present disclosure is: the issue of complete and uniform traceability of object circulation information.

Some embodiments of the present disclosure provide a platform for tracing an object, comprising: a plurality of blockchain nodes, each blockchain node corresponding to an entity in object circulation and each blockchain node being configured to: record circulation information of the object circulating to the blockchain node in association with a traceability code of the object, wherein the plurality of blockchain nodes synchronize the traceability code and circulation information of the object with a blockchain synchronization technology.

In some embodiments, the circulation information of the object comprises attribute information generated when the object is created, the attribute information comprising basic attribute information and additional attribute information, wherein the basic attribute information is input to a blockchain node that creates the object, and the additional attribute information is automatically generated by the blockchain node that creates the object.

In some embodiments, the circulation information of the object comprises attribute information generated when the object is created, wherein the attribute information is signed with a private key of a creator and the creator is an entity corresponding to a blockchain node that creates the object.

In some embodiments, the circulation information of the object comprises transaction information generated when the object is traded, the transaction information comprising basic transaction information and additional transaction information, wherein the basic transaction information is input to a blockchain node that sells the object, and the additional transaction information is automatically generated by the blockchain node that sells the object.

In some embodiments, the circulation information of the object comprises transaction information generated when the object is traded, wherein the transaction information is signed with a private key of a seller, and the seller is an entity corresponding to a blockchain node that sells the object.

In some embodiments, the object is moved from information of objects owned by a seller to information of objects owned by a purchaser after the object is circulated through transaction, and the traceability code of the object is copied into information of objects that have been sold of the seller to achieve synchronization between the seller and the purchaser.

In some embodiments, each blockchain node is further configured to provide a traceability interface, through which the traceability code of the object to be traced can be input, so as to enable querying of circulation information associated with the traceability code of the object to be traced.

In some embodiments, each blockchain node is an alliance chain node, and the entity comprises a manufacturer, a brand owner, a trader, a testing organization, a transport organization, or a regulatory agency.

Some embodiments of the present disclosure provide a method for tracing an object based on the platform for tracing an object, comprising: inputting a traceability code of the object to be traced through the platform for tracing an object; and querying circulation information of the object to be traced in the platform for tracing an object according to the traceability code.

In some embodiments, the method further comprising: recoding circulation information of an object circulating to any blockchain node of the platform for tracing an object in association with a traceability code of the object, and synchronizing the traceability code and circulation information of the object with a blockchain synchronization technology by a plurality of blockchain nodes of the platform for tracing an object.

In some embodiments, the circulation information of the object comprises attribute information generated when the object is created, the attribute information comprising basic attribute information and additional attribute information, wherein the basic attribute information is input to a blockchain node that creates the object, and the additional attribute information is automatically generated by the blockchain node that creates the object.

In some embodiments, the circulation information of the object comprises attribute information generated when the object is created, wherein the attribute information is signed with a private key of a creator and the creator is an entity corresponding to a blockchain node that creates the object.

In some embodiments, the circulation information of the object comprises transaction information generated when the object is traded, the transaction information comprising basic transaction information and additional transaction information, wherein the basic transaction information is input to a blockchain node that sells the object, and the additional transaction information is automatically generated by the blockchain node that sells the object.

In some embodiments, the circulation information of the object comprises transaction information generated when the object is traded, wherein the transaction information is signed with a private key of a seller, and the seller is an entity corresponding to a blockchain node that sells the object.

Some embodiments of the present disclosure provide a device for tracing an object, comprising: a memory; and a processor coupled to the memory, which is configured to execute the method for tracing an object based on instructions stored in the memory.

Some embodiments of the present disclosure provide a computer-readable storage medium storing a computer program, the computer program carrying out the steps of the method for tracing an object when executed by a processor.

Through deploying blockchain nodes for various entities in object circulation, recoding circulation information of an object circulating to any blockchain node in association with a traceability code of the object by the blockchain node, and synchronizing the traceability code and circulation information of the object with a blockchain synchronization technology by a plurality of blockchain nodes, complete and unified circulation information of the object can be queried from any blockchain node, thereby achieving complete and unified traceability of the circulation information of the object.

Other features and advantages of the present invention will become apparent through the following detailed description of exemplary embodiments of the present disclosure with reference to the accompanying drawings.

### BRIEF DESCRIPTION OF THE DRAWINGS

The accompanying drawings described herein are used to provide a further understanding of the present disclosure and constitute apart of this specification. The exemplary embodiments of the present disclosure and the descriptions thereof are used to explain the present disclosure and do not constitute an improper limitation on the present disclosure. In the drawings:

FIG. 1 is a schematic diagram of a platform for tracing an object according to some embodiments of the present disclosure;

FIG. 2 is a schematic diagram of functional modules of a blockchain node of the present disclosure;

FIG. 3 is a schematic structural diagram of a device for tracing an object according to some embodiments of the present disclosure;

FIG. 4 is a schematic flowchart of a method for tracing an object based on a platform for tracing an object according to some embodiments of the present disclosure;

FIG. 5 is a schematic flowchart of a method for tracing an object based on a platform for tracing an object according to other embodiments of the present disclosure.

### DETAILED DESCRIPTION

Below, a clear and complete description will be given for the technical solution of embodiments of the present disclosure with reference to the drawings of the embodiments.

This disclosure is provided to solve the issue of complete and unified traceability of object circulation information in the related art, and the crisis of confidence in the tracing of object circulation information.

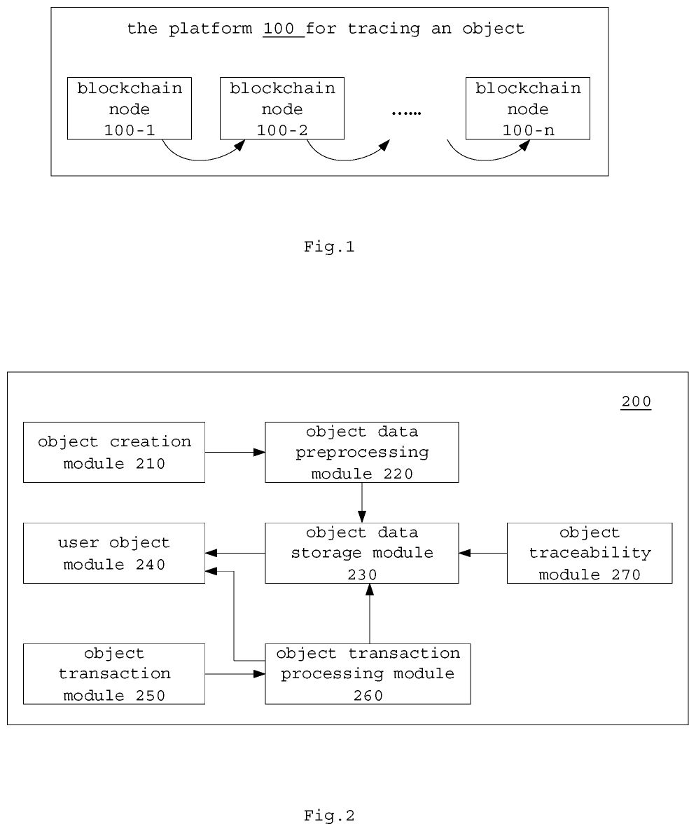

FIG. 1 is a schematic diagram of a platform for tracing an object according to some embodiments of the present disclosure.

As shown in FIG. 1, the platform 100 for tracing an object comprises: a number of blockchain nodes 100-1, 100-2, . . . , 100-n, each blockchain node corresponding to an entity in object circulation. These entities comprise, but are not limited to, for example, a manufacturer, a brand owner, a trader, a testing organization, transport organization, and a regulatory agency.

Each of blockchain nodes 100-1, 100-2, . . . , 100-n is configured to assign a unique traceability code to an object created on this blockchain node, and record circulation information of an object circulating to this blockchain node in association with the traceability code of the object. The plurality of blockchain nodes synchronize the traceability code and circulation information of the object with a blockchain synchronization technology.

The traceability code is unique on the platform 100 for tracing an object and cannot be changed once it is generated. Each traceability code represents an object in the real world, which can be one or a combination of numbers, letters, and symbols.

Therefore, complete and unified circulation information of the object can be obtained by querying on any blockchain node based on the traceability code, and complete and unified traceability of object circulation information can be achieved. Further, a trusted platform for tracing an object can be implemented based on the security and anti-tampering features of the blockchain.

Object circulation mainly comprises two stages, i.e., object creation and transaction circulation. Of course, an object may go through multiple transaction circulations. Object creation usually corresponds to object production. Object circulation information comprises attribute information generated when the object is created and transaction information generated when the object is traded. In conjunction with the functional modules of the blockchain node 200 shown in FIG. 2, a working process of the blockchain nodes will be described below in terms of an object creation stage and a transaction circulation stage.

Object Creation Stage

In the object creation stage, the blockchain node can provide an interface for entering attribute information of a newly-created object, provide a function of supplement the attribute information of the newly-created object, and a function of storing the object attribute information, and can also sign the object attribute information.

Below, a working process of the blockchain node in the object creation stage will be particularly described in conjunction with the functional modules of the blockchain node 200 shown in FIG. 2.

First, an object creation module 210 can provide an interface for entering attribute information of a newly-created object, so that a user (such as a manufacturer) can enter attribute data of the newly created object through the entry interface, such as an object name, an object ID (it's only required that the object ID is unique to the creator), an object model, a production date and other basic attribute information.

Next, an object data preprocessing module 220 supplements the attribute information of the newly created object submitted by the object creation module 210. The supplementary attribute data comprises, for example, additional attribute information such as a creator, a creation timestamp, a current owner of the object, and a traceability code. Wherein, the creator and traceability code must be supplemented completely. The creation time stamp and the current owner of the object may be optional, but usually also need to be supplemented. The additional attribute information may be automatically generated. Since a user often needs to log into the blockchain node system before inputting information, the login user can be extracted as the creator. The traceability code can be automatically generated by traceability code generation logic, which is unique and cannot be changed in the entire platform for tracing an object. The initial value of the current owner of the object is the creator. As the object is traded, the value of the current owner of the object changes accordingly, and is modified to the purchaser after each transaction. Then, the traceability code generation logic uses the creator's private key to sign the object attribute information, and the signature data is filled into the creator's signature attribute. The creator is an entity corresponding to the blockchain node that creates the object. The creator cannot deny the signature, thereby improving the trust issue when the circulation information of the object is traced. At this point, the data preprocessing is completed.

Next, an object data storage module 230 persistently stores the object attribute information processed by the object data preprocessing module 220. After the storage is successful, a user object module 240 can be called for processing.

Finally, the user object module 240 stores the traceability code of the newly created object in “My objects”. “My objects” are objects owned by the entity of the relevant blockchain node.

At this point, the object is created and the user can trade the object.

The object information stored by the object data storage module 230 for the newly created object is as follows:

```
    {
    “Traceability Code”: a traceability code,
    “Object Information”:
      {
      “Traceability Code”: the traceability code,
      “Object Name”: the name of the object,
      “Object ID”: the unique identification of the object,
      “Object Model”: an object model,
      “Production Date”: a production date,
      “Timestamp”: a timestamp
      }
  “Creator”: the account of the creator,
  “Creator Signature”: the creator's signature,
  “Current Owner of Object”: the account of the current owner of the
object
    }
```

“My objects” can be stored in the form of Key and Value. The key (K) stores a traceability code. The value (V) is stored as follows:

{
“Traceability Code”: the traceability code,
“Object Name”: the name of the object,
“Object ID”: the unique identification of the object,
“Object Model”: an object model,
“Production Date”: a production date,
“Timestamp”: a timestamp
}

Object Transaction Circulation Stage

In object transaction circulation stage, a blockchain node can provide an object transaction interface, process the transaction, record the object transaction information, and sign the object transaction information.

Below, a working process of the blockchain node in object transaction circulation stage will be described in detail with reference to the functional modules of the blockchain node 200 shown in FIG. 2.

First, an object transaction module 250 provides an object transaction interface. Through the transaction interface, the owner of the object can trade his own object to other people. The two parties in the transaction are the seller and purchaser, that is, the seller of the object can trade his own object to the purchaser through the transaction interface. During the transaction, the seller selects the traceability code of the object to be traded, then selects a purchaser, and finally submits a transaction request to an object transaction processing module 260. The transaction request usually comprises information such as the traceability code of the transaction object, the seller, and the purchaser. Basic transaction information such as the traceability code and the purchaser is usually entered by the seller to the corresponding blockchain node of the seller. Additional transaction information such as the seller and a sale time can be automatically generated by the blockchain node that sells the object. For example, a user who logs into the blockchain node system can be extracted as seller information without user input.

Next, the object transaction processing module 260 can move the transaction object from the seller's “My objects” to the purchaser's “My objects” according to the traceability code of the transaction object, the seller, and the purchaser, and then copy the traceability code of the transaction object to the “Sold objects” of the seller, thereby synchronizing the information between the seller and the purchaser. The same kind of objects can be stored in “Sold objects” multiple times. Then, the seller's private key is used to sign the object transaction information (traceability code of the transaction object, the seller, the purchaser, the transaction time, etc.), and the signature data is recorded in the transaction data signature attribute. The seller cannot deny the signature, thereby improving the trust issue when the circulation information of the object is traced. Finally, the object data storage module 230 is called.

Finally, the object data storage module 230 stores the transaction information of the successfully traded object in a transaction information list of the object. Also, the current owner of the object is modified to the purchaser.

At this point, the transaction processing of the object is completed.

The object information stored by the object data storage module 230 for the object that has been successfully traded is as follows:

```
    {
    “Traceability Code”: a traceability code,
    “Object Information”:
      {
        “Traceability Code”: the traceability code,
        “Object Name”: the name of the object,
        “Object ID”: the unique identification of the object,
        “Object Model”: an object model,
        “Production Date”: a production date,
        “Timestamp”: a timestamp
        }
  “Creator”: the account of the creator,
  “Creator Signature”: the creator's signature,
  “Current Owner of Object”: the account of the current owner of the
object
    “Transaction Information”: {
      {
      “Transaction ID”: a transaction ID,
      “Transaction Time”: a transaction time,
      “Seller of Object”: the seller's account,
      “Purchaser of Object”: the purchaser's account,
        “Transaction Data Signature”: a signature of transaction
data
        }
      }
    }
```

“Sold objects” can be stored in the form of Key and Value. The key (K) stores a traceability code. The value (V) is stored as follows:

```
  {
  “Traceability Code”: traceability code,
  “Object Name”: the name of the object,
  “Object ID”: the unique identification of the object,
  “Object Model”: an object model,
  “Production Date”: a production date,
  “Timestamp”: a timestamp,
  “Transaction Information”: {
      {
“Transaction ID”: a transaction ID,
“Transaction Time”: a transaction time,
“Seller of Object”: the seller's account,
“Purchaser of Object”: the purchaser's account,
“Transaction Data Signature”: a signature of transaction data
      }
    }
}
```

For example, for an object named “JDtabJ01”, produced by JD.COM and sold to YH001, and then sold to YH002 by YH001, the complete circulation information of the object recorded by the platform for tracing an object is as follows:

```
  {
  “Traceability Code”: “22578643511021”,
  “Object Information”:
    {
      “Traceability Code”: “22578643511021”,
      “Object Name”: “JDtabJ01”,
      “Object ID”: “JDtabJ0100000001”,
      “Object Model”: “J01”,
      “Production Date”: “2016/12/12”,
      “Timestamp”: “456874565456”
      }
“Creator”: “JD.COM”,
“Creator Signature”: “NASKDAIHLOJFYUUG7HLDVNCXVBWYT”,
“Current Owner of Object”: “YH002”
  “Transaction Information”: {
    {
    “Transaction ID”: “NABS-ASDA-VIDN-KFSN-SDFS-IEIE”,
    “Transaction Time”: “2016/12/20 09: 30: 00”,
    “Seller of Object”: “JD.COM”,
    “Purchaser of Object”: “YH001”,
      “Transaction Data Signature”: “LKHGJLIFDTRXVNBBM7FY0BCV”
      }
      {
    “Transaction ID”: “SWCF-ASDA-TIDN-RFSN-EDFS-YDSA”,
    “Transaction Time”: “2017/01/12 12: 31: 00”,
    “Seller of Object”: “YH001”,
    “Purchaser of Object”: “YH002”,
      “Transaction Data Signature”: “BXKOKDPO8AOPYTG4NFMLPF”
      }
    }
  }
```

JD.COM company records and generates “Traceability code”, “Object Information” and the first transaction record, YH001 records and generates the second transaction record, and all participating entities JD.COM, YH001, and YH002 can obtain the whole circulation records of the object JDtabJ01, comprising a creation record and all transaction records.

In order to achieve the traceability function, the blockchain node 200 can be further provided with an object traceability module 270 capable of providing a traceability interface. The traceability code of an object to be traced can be input through the traceability interface, so as to enable querying of circulation information in associated with the traceability code of the object in the object data storage module 230, comprising the creation record and all transaction records.

The above platform for tracing an object is established on the basis of a decentralized, tamper-resistant, and trusted blockchain technology. Companies, government departments, regulatory agencies, consumers, and other entities can participate in the supervision and maintenance of object circulation data. In the circulation of an object, each entity will record and sign the circulation data of the object, and a blockchain node corresponding to the entity automatically synchronizes the circulation data to other blockchain nodes, so that each entity has the circulation data and the content is the same. It is impossible for an entity to tamper the content. Therefore, compared with the traceability data from only one company, the traceability data generated by multiple entities can be more convincing to consumers and more credible.

The traceability scheme of the present disclosure can be applied to a commodity traceability service. In the commodity traceability service, the blockchain of the traceability platform can be realized based on an alliance chain. The entities of the alliance chain comprise, but are not limited to, for example, a brand owner, a manufacturer, a trader, a testing organization, transport organization, and a regulatory agency, etc., each of them corresponding to an alliance chain node.

Applying the traceability solution of this disclosure, enterprise users can track the sales flow of their produced objects. The real supply chain data of the objects in the platform for tracing an object can help enterprises analyze the real information such as the sales channels and purchase groups of their objects, and provide data support for future precision marketing. If there is a quality problem with an object, the enterprise or a regulatory department can use the data of the platform for tracing an object to quickly find the user to which the object currently belongs, thereby reducing labor costs. Customers can learn all the production information, transaction information, sales channels, etc. of objects when purchasing the objects. The information is true, transparent, and credible, which provides strong support for consumers' purchase decisions.

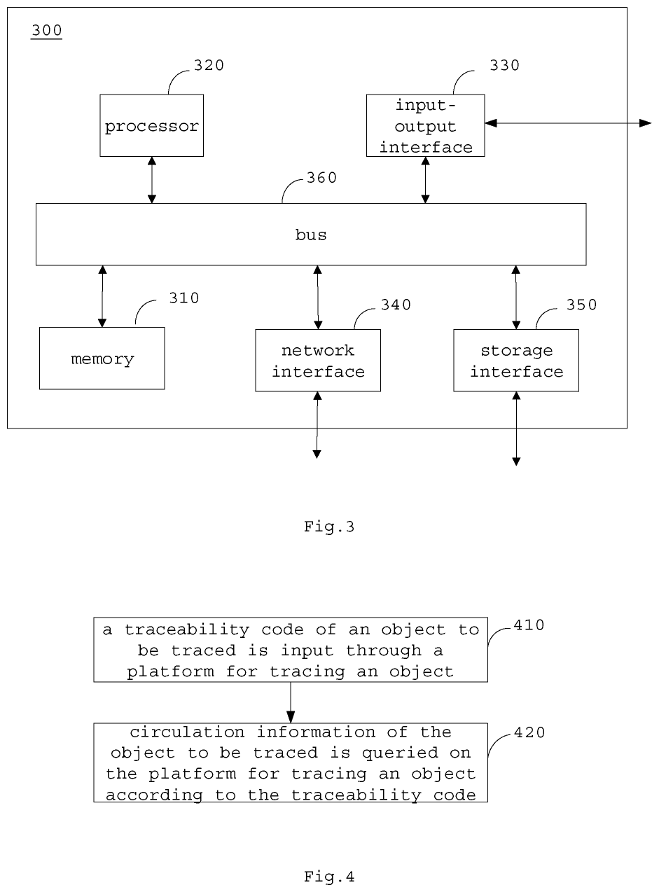

FIG. 3 is a schematic structural diagram of a device for tracing an object according to some embodiments of the present disclosure. As shown in FIG. 3, the device 300 of this embodiment comprises a memory 310 and a processor 320 coupled to the memory 310. The processor 320 is configured to execute the method for tracing an object of any one of the embodiments based on instructions stored in the memory 310.

The memory 310 may comprise, for example, system memory, a fixed non-volatile storage medium, or the like. The system memory stores, for example, an operating system, application programs, a boot loader, and other programs.

The device 300 may further comprise an input-output interface 330, a network interface 340, a storage interface 350, and the like. These interfaces 330, 340, 350, the memory 310 and the processor 320 may be connected through a bus 360, for example. The input-output interface 330 provides a connection interface for input/output devices such as a display, a mouse, a keyboard, and a touch screen. The network interface 340 provides a connection interface for various networked devices. The storage interface 350 provides a connection interface for external storage devices such as an SD card and a USB flash disk.

FIG. 4 is a schematic flowchart of a method for tracing an object based on a platform for tracing an object according to some embodiments of the present disclosure.

As shown in FIG. 4, the method for tracing an object in this embodiment comprises steps 410-420.

In step 410, a traceability code of an object to be traced is input through a platform for tracing an object.

For example, the traceability code of the object to be traced can be input through any blockchain node of the platform for tracing an object.

In step 420, circulation information of the object to be traced is queried on the platform for tracing an object according to the traceability code.

For example, circulation information of the object to be traced is queried from any blockchain node of the platform for tracing an object according to the traceability code.

Complete and unified circulation information of the object can be obtained by querying from any blockchain node of the platform for tracing an object, so that complete and unified traceability of object circulation information can be achieved.

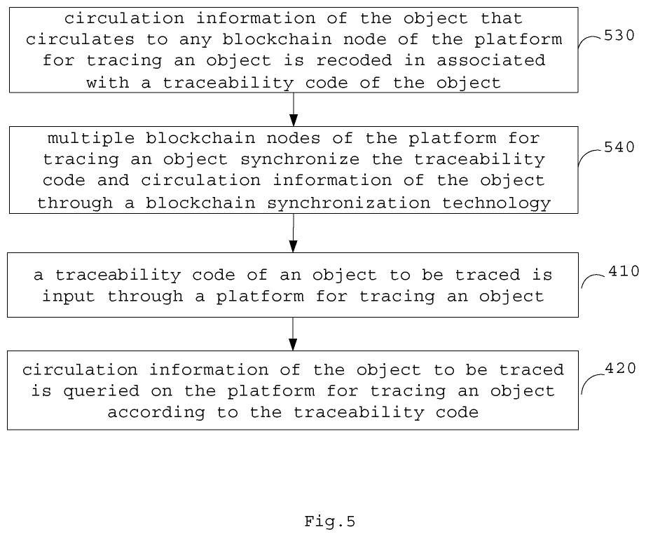

FIG. 5 is a schematic flowchart of a method for tracing an object based on a platform for tracing an object according to other embodiments of the present disclosure.

As shown in FIG. 5, in addition to steps 410-420, the method for tracing an object of this embodiment may optionally comprise steps 530-540.

In step 530, circulation information of the object that circulates to any blockchain node of the platform for tracing an object is recoded in associated with a traceability code of the object.

In step 540, multiple blockchain nodes of the platform for tracing an object synchronize the traceability code and circulation information of the object through a blockchain synchronization technology.

In some embodiments, the circulation information of the object comprises attribute information generated when the object is created, and the attribute information comprises basic attribute information and additional attribute information. The basic attribute information is input to a blockchain node that creates the object. The additional attribute information is automatically generated by the blockchain node that creates the object.

In some embodiments, the circulation information of the object comprises transaction information generated when the object is traded, and the transaction information comprises basic transaction information and additional transaction information. The basic transaction information is input to a blockchain node that sells the object. The additional transaction information is automatically generated by the blockchain node that sells the object.

The information automatically generated by a blockchain node is not easy to be modified by related entities, which can improve the credibility to a certain extent.

In some embodiments, the attribute information is signed with a private key of a creator, and the creator is an entity corresponding to the blockchain node that creates the object.

In some embodiments, the transaction information is signed with a private key of a seller, and the seller is an entity corresponding to a blockchain node that sells the object.

In each stage of object circulation, the private key of the circulation entity can be used to sign the object circulation information, and the circulation entity cannot deny the signature, thereby improving the trust issue when the object circulation information is traced.

The present disclosure further provides a computer-readable storage medium storing a computer program that carries out the steps of the method for tracing an object in any one of the foregoing embodiments when executed by a processor.

Those skilled in the art should understand that the embodiments of the present disclosure may be provided as a method, a system, or a computer program product. Therefore, embodiments of the present disclosure can take the form of an entirely hardware embodiment, an entirely software embodiment or an embodiment containing both hardware and software elements. Moreover, the present disclosure may take the form of a computer program product embodied on one or more computer-usable non-transitory storage media (comprising but not limited to disk storage, CD-ROM, optical memory, etc.) having computer-usable program code embodied therein.

The present disclosure is described with reference to flowcharts and/or block diagrams of methods, apparatuses (systems) and computer program products according to embodiments of the present disclosure. It should be understood that each process and/or block in the flowcharts and/or block diagrams, and combinations of the processes and/or blocks in the flowcharts and/or block diagrams may be implemented by computer program instructions. The computer program instructions may be provided to a processor of a general purpose computer, a special purpose computer, an embedded processor, or other programmable data processing device to generate a machine such that the instructions executed by a processor of a computer or other programmable data processing device to generate means implementing the functions specified in one or more flows of the flowcharts and/or one or more blocks of the block diagrams.

The computer program instructions may also be stored in a computer readable memory device capable of directing a computer or other programmable data processing device to operate in a specific manner such that the instructions stored in the computer readable memory device produce an object of manufacture comprising instruction means implementing the functions specified in one or more flows of the flowcharts and/or one or more blocks of the block diagrams.

These computer program instructions can also be loaded onto a computer or other programmable device to perform a series of operation steps on the computer or other programmable device to generate a computer-implemented process such that the instructions executed on the computer or other programmable device provide steps implementing the functions specified in one or more flows of the flowcharts and/or one or more blocks of the block diagrams.

The above description is merely preferred embodiments of this disclosure, and is not limitation to this disclosure. Within spirit and principles of this disclosure, any modification, replacement, improvement and etc. shall be contained in the protection scope of this disclosure.

1. A platform for tracing an object, comprising:
a plurality of blockchain nodes, each blockchain node corresponding to an entity in object circulation and each blockchain node being configured to record circulation information of the object circulating to the blockchain node in association with a traceability code of the object,
wherein the plurality of blockchain nodes synchronize the traceability code and circulation information of the object with a blockchain synchronization technology.

2. The platform for tracing an object according to claim 1, wherein
the circulation information of the object comprises attribute information generated when the object is created, the attribute information comprising basic attribute information and additional attribute information, wherein
the basic attribute information is input to a blockchain node that creates the object, and
the additional attribute information is automatically generated by the blockchain node that creates the object.

3. The platform for tracing an object according to claim 1, wherein
the circulation information of the object comprises attribute information generated when the object is created, wherein the attribute information is signed with a private key of a creator and the creator is an entity corresponding to a blockchain node that creates the object.

4. The platform for tracing an object according to claim 1, wherein
the circulation information of the object comprises transaction information generated when the object is traded, the transaction information comprising basic transaction information and additional transaction information, wherein
the basic transaction information is input to a blockchain node that sells the object, and
the additional transaction information is automatically generated by the blockchain node that sells the object.

5. The platform for tracing an object according to claim 1, wherein
the circulation information of the object comprises transaction information generated when the object is traded, wherein the transaction information is signed with a private key of a seller, and the seller is an entity corresponding to a blockchain node that sells the object.

6. The platform for tracing an object according to claim 1, wherein
information of the object is deleted from information of objects owned by a seller and recorded into information of objects owned by a purchaser after the object is circulated through transaction, and the traceability code of the object is copied into information of objects that have been sold of the seller to achieve synchronization between the seller and the purchaser.

7. The platform for tracing an object according to claim 1, wherein
each blockchain node is further configured to provide a traceability interface for inputting the traceability code of the object to be traced, so as to enable querying of circulation information associated with the traceability code of the object to be traced.

8. The platform for tracing an object according to claim 1, wherein
each blockchain node is an alliance chain node, and the entity comprises a manufacturer, a brand owner, a trader, a testing organization, a transport organization, or a regulatory agency.

9. A method for tracing an object based on the platform for tracing an object of claim 1, comprising:
receiving a traceability code of the object to be traced input through the platform for tracing an object; and
querying circulation information of the object to be traced in the platform for tracing an object according to the traceability code.

10. The method for tracing an object according to claim 9, further comprising:
recoding circulation information of an object circulating to any blockchain node of the platform for tracing an object in association with a traceability code of the object, and
synchronizing the traceability code and circulation information of the object with a blockchain synchronization technology by a plurality of blockchain nodes of the platform for tracing an object.

11. The method for tracing an object according to claim 10, wherein
the circulation information of the object comprises attribute information generated when the object is created, the attribute information comprising basic attribute information and additional attribute information, wherein
the basic attribute information is input to a blockchain node that creates the object, and
the additional attribute information is automatically generated by the blockchain node that creates the object.

12. The method for tracing an object according to claim 10, wherein
the circulation information of the object comprises attribute information generated when the object is created, wherein the attribute information is signed with a private key of a creator and the creator is an entity corresponding to a blockchain node that creates the object.

13. The method for tracing an object according to claim 10, wherein
the circulation information of the object comprises transaction information generated when the object is traded, the transaction information comprising basic transaction information and additional transaction information, wherein
the basic transaction information is input to a blockchain node that sells the object, and
the additional transaction information is automatically generated by the blockchain node that sells the object.

14. The method for tracing an object according to claim 10, wherein
the circulation information of the object comprises transaction information generated when the object is traded, wherein the transaction information is signed with a private key of a seller, and the seller is an entity corresponding to a blockchain node that sells the object.

15. A device for tracing an object, comprising:
a memory; and
a processor coupled to the memory, which is configured to execute the method for tracing an object according to claim 9 based on instructions stored in the memory.

16. A non-transitory computer-readable storage medium storing a computer program, the computer program carrying out the steps of the method for tracing an object according to claim 9 when executed by a processor.

17. The device for tracing an object according to claim 15, wherein the processor is further configured to
recode circulation information of an object circulating to any blockchain node of the platform for tracing an object in association with a traceability code of the object, and
synchronize the traceability code and circulation information of the object with a blockchain synchronization technology.

18. The computer-readable storage medium according to claim 16, wherein the computer program further carries out the following steps:
recoding circulation information of an object circulating to any blockchain node of the platform for tracing an object in association with a traceability code of the object, and
synchronizing the traceability code and circulation information of the object with a blockchain synchronization technology.

19. A method for tracing an object based on the platform for tracing an object of claim 1, comprising:
inputting a traceability code of the object to be traced through the platform for tracing an object; and
querying circulation information of the object to be traced in the platform for tracing an object according to the traceability code.

20. The method for tracing an object according to claim 19, wherein the circulation information of the object comprises attribute information generated when the object is created and transaction information generated when the object is traded.
